(19) United States
(12) Patent Application Publication
(10) Pub. No.: US 2013/0255038 A1
(43) Pub. Date: Oct. 3, 2013

(54) SHOELACE POSITIONING STRUCTURE

(71) Applicant: YU-SHAN LAI, NEW TAIPEI CITY (TW)

(72) Inventor: YU-SHAN LAI, NEW TAIPEI CITY (TW)

(21) Appl. No.: 13/432,071

(22) Filed: Mar. 28, 2012

(51) Int. Cl. A43C 7/02; F16B 47/00

(52) U.S. Cl. 24/304

(57) ABSTRACT

A shoelace positioning structure includes a pair of adhesive straps at two sides of a shoe and a positioning member on a vamp. The positioning member includes a through hole and two positioning rods with engaging heads at upper ends of the two positioning rods. The two positioning rods are adapted for winding of a shoelace. The engaging heads can prevent the shoelace from loosening. The adhesive straps wrap and stick the shoelace to position the shoelace thereat. The shoelace can be positioned quickly without tying a knot.

### BACKGROUND OF THE INVENTION

1. Field of the Invention

The present invention relates to a shoelace positioning structure, and more particularly to one that positions a shoelace by winding, not by tying a knot. The shoelace can be positioned quickly.

2. Description of the Related Art

In general, a shoelace is positioned by tying a knot, namely, both ends of the shoelace are tied in a bow. This has the following drawbacks. To tie a bow is complicated, troublesome and time-consuming. For children, it is not easy to learn tying a bow. They always need help to tie the shoelace. The bow is easy to loosen or may untie if someone step on the shoelace. The bow on the vamp is burdensome. Accordingly, the inventor of the present invention has devoted himself based on his many years of practical experiences to solve these problems.

### SUMMARY OF THE INVENTION

The primary object of the present invention is to provide a shoelace positioning structure which comprises a pair of adhesive straps at two sides of a shoe and a positioning piece on a vamp. The positioning piece is connected with a U-shaped positioning member. The positioning member comprises a through hole and two positioning rods with engaging heads at upper ends of the two positioning rods. The two positioning rods are adapted for winding of a shoelace. The engaging heads can prevent the shoelace from loosening. The adhesive straps wrap and stick the shoelace to position the shoelace thereat. For children, the shoelace can be positioned quickly, without tying a knot.

### BRIEF DESCRIPTION OF THE DRAWINGS

FIG. 1 is an exploded view according to a preferred embodiment of the present invention.

FIG. 2 is a schematic showing the preferred embodiment of the present invention coupled to the vamp.

FIG. 3 is a schematic showing the winding of the shoelace according to the preferred embodiment of the present invention.

FIG. 4 is a schematic showing the shoelace be positioned according to the preferred embodiment of the present invention.

FIG. 5 is a perspective showing the positioning member and the decoration piece according to the preferred embodiment of the present invention.

### DETAILED DESCRIPTION OF THE PREFERRED EMBODIMENT

Embodiments of the present invention will now be described, by way of example only, with reference to the accompanying drawings.

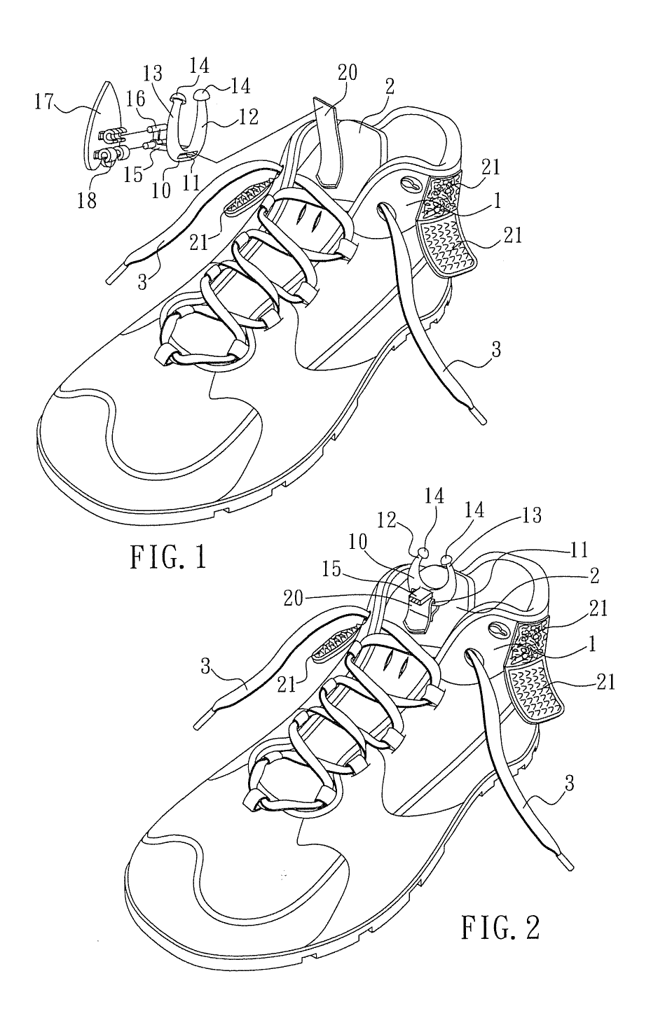

As shown in FIG. 1 through FIG. 5, the shoelace positioning structure according to a preferred embodiment of the present invention comprises a pair of adhesive straps (Velcro strap) at two sides of a shoe 1 and a positioning piece 20 on a vamp 2. The positioning piece 20 is connected with a positioning member 10. The positioning member 10 comprises a through hole 11 and two positioning rods 12;13 with engaging heads 14 at upper ends of the two positioning rods 12;13. The through hole 11 is adapted for insertion of the positioning piece 20 of the vamp 2. The positioning member 10 further comprises an extension portion 15 which is integrally formed with the positioning member 10. The extension portion 15 comprises a shaft 16 and a decoration piece 17 thereon. The decoration piece 17 has a C-like engaging seat 18 to engage with the shaft 16, so that the decoration piece 17 is connected to the positioning member 10.

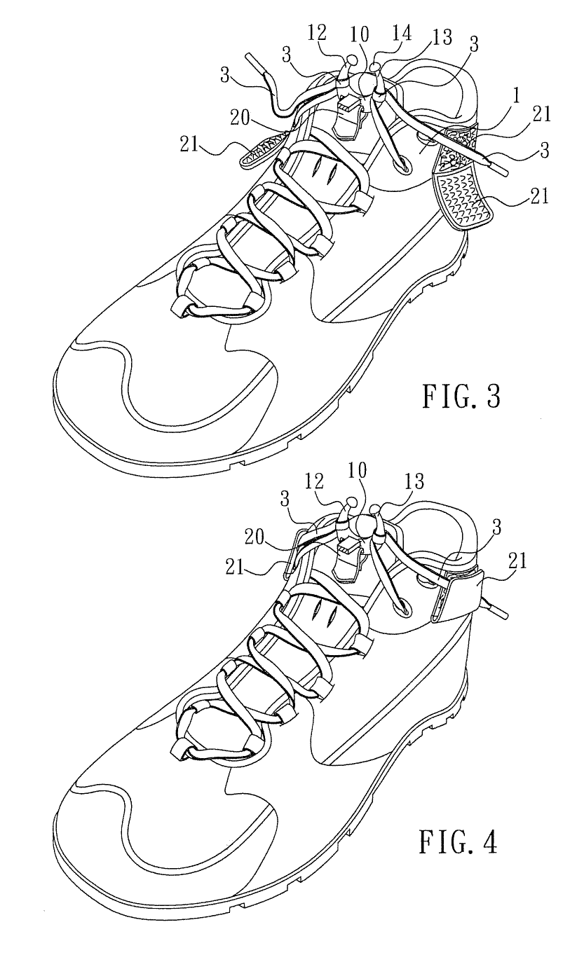

When in use, as shown in FIG. 3, two ends of the shoelace 3 are wound around the two positioning rods 12;13 to hold the shoelace 3, and then the two ends of the shoelace 3 are adhered to the pair of adhesive straps 21 of the shoe 1. As shown in FIG. 4, the adhesive straps 21 wrap and stick the shoelace 3 to position the shoelace 3 thereat. When taking off the shoe, the adhesive straps 21 are opened to release the shoelace 3, alternatively, the shoelace 3 is pulled away from the positioning rods 12;13 to loosen the shoelace 3, without the need to open the adhesive straps 21. When putting on the shoe, the shoelace is wound around the positioning rods 12;13 again to position the shoelace 3. The present invention has the following effects and advantages. The shoelace 3 can be positioned quickly and easily by winding the shoelace 3. There is no need to tie a knot. Children can put on shoes and position the shoelaces by themselves. The engaging heads 14 of the positioning rods 12;13 are used to confine the shoelace 3. The shoelace 3 won't untie if the adhesive straps 21 are not opened by hand.

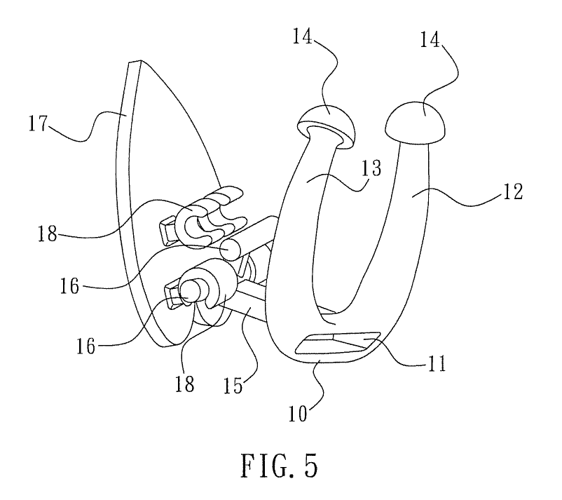

As shown in FIG. 5, the front surface of the decoration piece 17 has a pattern thereon to decorate the shoe. The front surface of the decoration piece 17 can have a character as the brand of the shoe. Through engagement of the engaging seat 18 and the shaft 16, the decoration piece 17 is rotatable and adjustable relative to the positioning member 10 and can be replaced quickly.

Although particular embodiments of the present invention have been described in detail for purposes of illustration, various modifications and enhancements may be made without departing from the spirit and scope of the present invention. Accordingly, the present invention is not to be limited except as by the appended claims.

What the invention claimed is:

1. A shoelace positioning structure, comprising a pair of adhesive straps at two sides of a shoe and a positioning piece on a vamp, the positioning piece being connected with a positioning member, the positioning member comprising a through hole and two positioning rods with engaging heads at upper ends of the two positioning rods, the through hole being adapted for insertion of the positioning piece of the vamp, the two positioning rods being adapted for winding of a shoelace, the engaging heads preventing the shoelace from loosening, the adhesive straps wrapping and sticking the shoelace to position the shoelace thereat.

2. The shoelace positioning structure as claimed in claim 1, wherein the positioning member further comprises an extension portion thereon, the extension portion comprising a shaft and a decoration piece thereon, the decoration piece having an engaging seat to engage with the shaft so that the decoration piece is connected to the positioning member.
